(19) United States
(12) Patent Application Publication
(10) Pub. No.: US 2012/0303943 A1
(43) Pub. Date: Nov. 29, 2012

(54) INFORMATION PROCESSING APPARATUS AND AUTHENTICATION CONTROL METHOD

(75) Inventors: Satoshi Tamura, Ome-shi (JP); Toru Hanada, Ome-shi (JP); Isamu Uchiyama, Ome-shi (JP); Gen Watanabe, Akishima-shi (JP)

(73) Assignee: KABUSHIKI KAISHA TOSHIBA, TOKYO (JP)

(21) Appl. No.: 13/398,628

(22) Filed: Feb. 16, 2012

(30) Foreign Application Priority Data
May 27, 2011 (JP) 2011-119292

(51) Int. Cl. G06F 21/00

(52) U.S. Cl. 713/2

(57) ABSTRACT

According to one embodiment, a control module determines whether a second authentication key is present in a authentication key storage device when an information processing apparatus is powered on. The control module displays an identification code input screen for inputting an identification code if the second authentication key is not present, causes a storage device to execute an identification code authentication process of determining whether the identification code which is input to the identification code input screen agrees with the first identification code, and generates a third authentication key and stores the third authentication key in the authentication key storage device if the identification code authentication process is successfully carried out.

### CROSS-REFERENCE TO RELATED APPLICATIONS

This application is based upon and claims the benefit of priority from prior Japanese Patent Application No. 2011-119292, filed May 27, 2011, the entire contents of which are incorporated herein by reference.

### FIELD

Embodiments described herein relate generally to an information processing apparatus comprising a storage device, and an authentication control method which is applied to the apparatus.

### BACKGROUND

In recent years, there has been a demand for prevention of information leak due to, e.g. a theft of a storage device such as a hard disk drive (HDD) or a solid-state driver (SSD).

Recently, a storage device having a device authentication function has recently begun to be developed. The storage device having the device authentication function has various functions for protecting data, which is stored in the storage device, from unauthorized use.

In order to mount the storage device having the device authentication function in a personal computer, it is necessary that information for device authentication be stored in the personal computer.

However, it is possible that the information for device authentication stored in the personal computer is lost due to some cause such as a fault of the personal computer. In this case, since it is no longer possible to cause the storage device to authenticate the personal computer as an authorized device, access to data stored in the storage device becomes impossible.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an information processing apparatus according to an embodiment.

FIG. 2 is an exemplary block diagram illustrating a structure of the information processing apparatus according to the embodiment.

FIG. 3 is an exemplary block diagram illustrating a system configuration of the information processing apparatus according to the embodiment.

FIG. 4 is an exemplary flow chart illustrating an example of the procedure of an authentication control process which is executed by the information processing apparatus according to the embodiment.

FIG. 5 is an exemplary flow chart illustrating another example of the procedure of the authentication control process which is executed by the information processing apparatus according to the embodiment.

### DETAILED DESCRIPTION

Various embodiments will be described hereinafter with reference to the accompanying drawings.

In general, according to one embodiment, an information processing apparatus comprises a storage device, an authentication key storage device and a control module. The storage device is configured to store a first identification code indicative of an owner of the storage device and a first authentication key. The authentication key storage device is configured to store a second authentication key which is identical to the first authentication key in the storage device. The control module is configured to determine, when the information processing apparatus is powered on, whether the second authentication key is present in the authentication key storage device, to cause, if the second authentication key is present, the storage device to execute a device authentication process of determining whether the second authentication key agrees with the first authentication key, and to boot up an operating system stored in the storage device if the device authentication process is successfully carried out. The control module is configured to display, if the second authentication key is not present, an identification code input screen for prompting a user to input an identification code and cause the storage device to execute an identification code authentication process of determining whether the identification code which is input to the identification code input screen agrees with the first identification code, and to generate, if the identification code authentication process is successfully carried out, a third authentication key and store the third authentication key in the authentication key storage device.

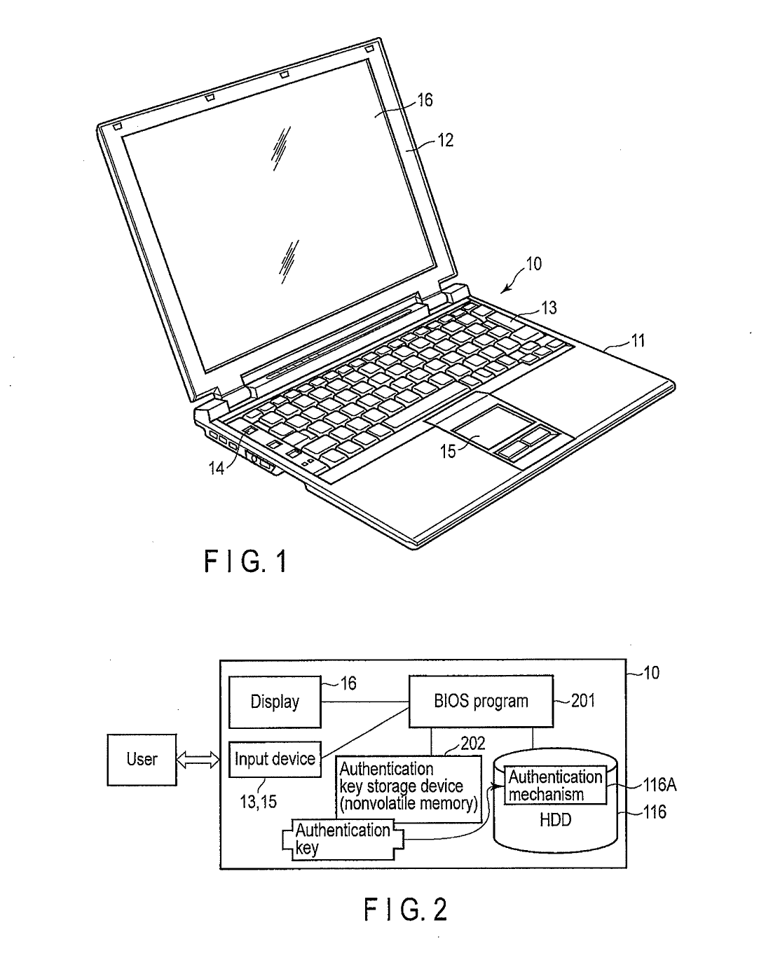

FIG. 1 is a perspective view showing the external appearance of an information processing apparatus according to an embodiment. This information processing apparatus may be realized, for example, as a notebook-type personal computer (PC) 10. Besides, this information processing apparatus may be realized as a server, a desktop PC, a tablet PC, a slate PC, etc.

As shown in FIG. 1, the computer 10 is composed of a computer main body 11 and a display unit 12. A display device, which is composed of an LCD (Liquid crystal Display) 16, is built in the display unit 12.

The display unit 12 is attached to the computer main body 11 such that the display unit 12 is rotatable between an open position where the top surface of the computer main body 11 is exposed, and a closed position where the top surface of the computer main body 11 is covered. The computer main body 11 has a thin box-shaped housing. A keyboard 13, a power button 14 for powering on/off the computer 10, a touch pad serving as a pointing device 15, for instance, are disposed on the top surface of the housing of the computer main body 11. In other types of information processing apparatuses, a mouse or a touch panel, for instance, may be provided as the pointing device 15.

FIG. 2 schematically illustrates the structure of the computer 10. The computer 10 comprises a hard disk drive (HDD) 116; an authentication key storage device 202; and a display device and an input device which function as user interfaces. The display device is composed of the above-described LCD 16. The input device is composed of the above-described keyboard 13 and pointing device 15. The HDD 116 is a storage device having a device authentication function. An authentication mechanism 116A of the HDD 116 is configured to execute a device authentication process for determining whether a device (host) which uses the HDD 116 is an authorized device or not, thereby prohibiting a device (unauthorized device), which is different from a specific device (authorized device) that is associated in advance with the HDD 116, from accessing data in the HDD 116. The HDD 116 has a plurality of operation modes, as described below, which have different security levels.

Mode 1: a mode in which data stored in the HDD 116 is invalidated when power supply to the HDD 116 has been turned off.

Mode 2: a mode in which data stored in the HDD 116 is invalidated when a device authentication process between the device, which incorporates the HDD 116, and the HDD 116 has failed.

Mode 3: a mode in which data (encrypted data) stored in the HDD 116 is not decrypted until the device authentication process is successfully carried out.

The HDD 116 may have a function of encrypting data and storing the encrypted data. In this case, the process of invalidating data may be executed by deleting a key (decryption key) for decrypting the encrypted data stored in the HDD 116.

Furthermore, the HDD 116 can invalidate data stored in the HDD 116, when access to the data in the HDD 116 has been executed without execution of the procedure of a predetermined device authentication.

In the present embodiment, the HDD 116 is used in a state in which the HDD 116 is set in an arbitrary mode other than Mode 1. A process of associating the HDD 116 and the computer 10 and a process of setting the HDD 116 in a predetermined operation mode may be executed by a worker in a factory at a stage prior to factory shipment of the computer 10, in accordance with the wish of a person who made an offer to purchase the computer 10. In the process of associating the HDD 116 and the computer 10 which is executed prior to factory shipment, the same authentication key is written in the HDD 116 and the authentication key storage device 202. The authentication key storage device 202 may be a nonvolatile memory. In addition, a personal identification number (PIN) is stored in the HDD 116. The PIN code is an identification code for identifying the owner of the HDD 116, that is, the purchaser of the computer 10.

A BIOS 201 is a program for controlling the hardware of the computer 10, and is configured to execute an authentication procedure corresponding to the device authentication function of the HDD 116. When the computer 10 is powered on, the BIOS 201 executes the following procedure:

(1) When the computer 10 is powered on, the BIOS 201 confirms whether an authentication key is stored in the authentication key storage device 202.

(2) If the authentication key is present, the BIOS 201 sends out the authentication key to the HDD 116, and causes the HDD 116 to execute the device authentication process. In the device authentication process, the HDD 116 determines whether the authentication key, which has been received from the BIOS 201, agrees with the authentication key in the HDD 116.

(3) When the device authentication process of the HDD 116 has successfully been carried out, that is, when the authentication key of the authentication key storage device 202 agrees with the authentication key in the HDD 116, access to data stored in the HDD 116 is enabled. The BIOS 201 read-accesses the HDD 116 and boots up the operating system stored in the HDD 116.

In usual cases, the operating system stored in the HDD 116 can normally be booted up. However, if the authentication key in the authentication key storage device 202 is broken or lost due to some factor, the operating system stored in the HDD 116 could not be booted up. The case is now assumed that the computer 10 (components other than HDD 116) faulted and the system board (motherboard) of the computer 10 was replaced with a new system board (motherboard) in a maintenance center. In this case, since nothing is stored in the authentication key storage device 202 on the new system board, there occurs a state in which the correct authentication key is lost. Unless the correct authentication key is present, the data in the HDD 116 cannot be accessed. Thus, the BIOS 201 of the computer 10 of the present embodiment is equipped with a remedy function for dealing with the case in which the authentication key was broken or lost. When the authentication key was lost, the procedure which is executed by the BIOS 201 is as follows:

(1) When the computer 10 is powered on, the BIOS 201 confirms whether an authentication key is stored in the authentication key storage device 202.

(2) If the authentication key is not present, the BIOS 201 causes the LCD 16 to display a message prompting the user to input a PIN, and waits for the PIN input by the user.

(3) If the PIN is input by the user, the BIOS 201 sends out the input PIN to the HDD 116, and causes the HDD 116 to execute a PIN authentication process (identification code authentication process). The PIN authentication process is a process for determining whether the user of the computer 10 is the owner of the HDD 116. In the PIN authentication process, the HDD 116 determines whether the PIN, which has been received from the BIOS 201, agrees with the PIN in the HDD 116, and returns the determination result to the BIOS 201.

(4) If the input PIN is an unauthorized PIN, that is, if the input PIN does not agree with the PIN in the HDD 116, the BIOS 201 powers off the computer 10.

(5) If the input PIN is the correct PIN, that is, if the input PIN agrees with the PIN in the HDD 116, the BIOS 201 generates a new authentication key and stores the new authentication key in the authentication key storage device 202, thereby to restore the computer 10 to the state in which the device authentication process can be executed. Needless to say, the new authentication key may not only be stored in the authentication key storage device 202, but may also be re-registered in the HDD 116. In this case, since the authentication key in the HDD 116 is changed to the new authentication key that is received from the BIOS 201, there is no need to generate a new authentication key that is identical to the original authentication key, and a new authentication key can more easily be generated.

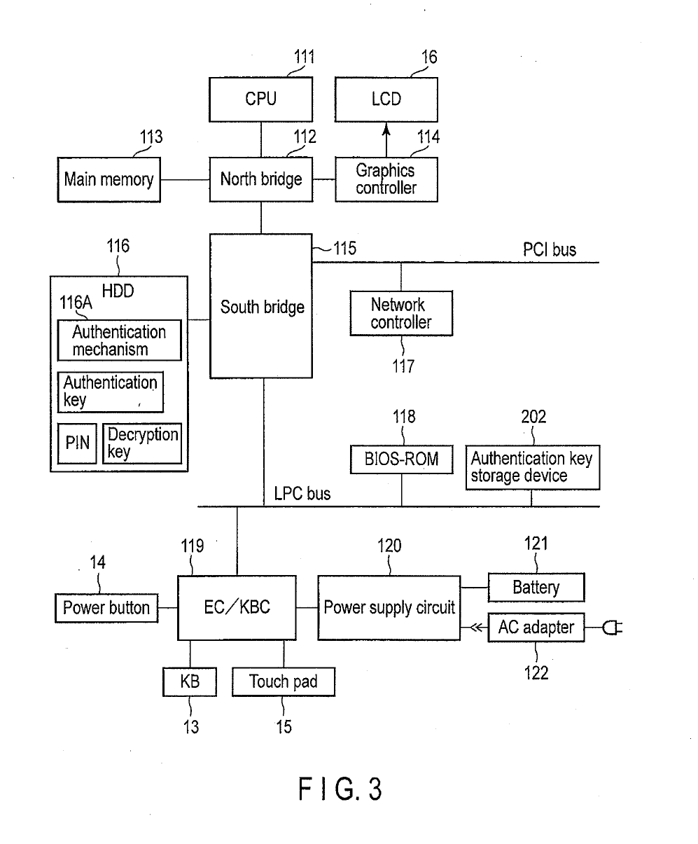

Next, referring to FIG. 3, an example of the system configuration of the computer 10 is described.

The computer 10 comprises a CPU 111, a north bridge 112, a main memory 113, a graphics controller 114, a south bridge 115, hard disk drive (HDD) 116, a network controller 117, a flash BIOS-ROM 118, an embedded controller/keyboard controller (EC/KBC) 119, and a power supply circuit 120.

The CPU 111 is a processor for controlling the operations of the respective components of the computer 10. The CPU 111 executes the above-described BIOS 201 which is stored in the flash BIOS-ROM 118. In addition, the CPU 111 executes an operating system and various application programs, which are loaded from the HDD 116 into the main memory 113.

The north bridge 112 is a bridge device which connects a local bus of the CPU 111 and the south bridge 115. In addition, the north bridge 112 has a function of communicating with the graphics controller 114. Furthermore, the north bridge 112 comprises a memory controller which controls the main memory 113.

The graphics controller 114 is a display controller which controls the LCD 16 that is used as a display monitor of the computer 10. The south bridge 115 is connected to a PCI (peripheral component interconnect) bus and an LPC (Low Pin Count) bus. The HDD 116 has the device authentication function, as described above. The HDD 116 is an HDD having a device authentication function which supports, for example, “Wipe Technology storage” which was developed by Kabushiki-Kaisha Toshiba. Needless to say, instead of the HDD 116, use may be made of a solid-state drive (SSD) having a device authentication function which supports “Wipe technology storage”.

The embedded controller/keyboard controller IC (EC/KBC) 119 is a one-chip microcomputer in which an embedded controller for power management and a keyboard controller for controlling the keyboard (KB) 13 and pointing device 15 are integrated. The EC/KBC 119 cooperates with the power supply circuit 120 to power on/off the computer 10 in accordance with an operation of the power button switch 14 by the user. The power supply circuit 120 generates system power, which is to be supplied to the respective components of the computer 10, by using power from a battery 121 that is incorporated in the computer main body 11, or external power which is supplied via an AC adapter 122.

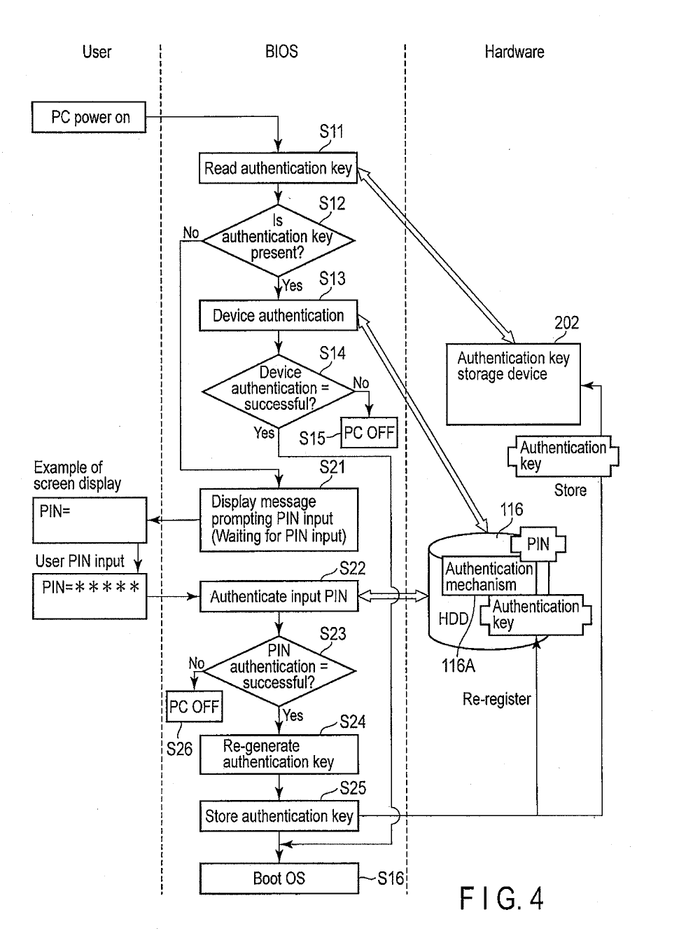

Next, referring to a flow chart of FIG. 4, a description is given of an example of the procedure of an authentication control process which is executed by the BIOS 201.

When the computer 10 has been powered on in response to an operation of the power button switch 14 by the user, the CPU 111 first executes the BIOS 201. The BIOS 201 read-accesses the authentication key storage device 202 and reads an authentication key from the authentication key storage device 202 (step S11). The BIOS 201 determines whether an authentication key is present in the authentication key storage device 202, based on the read result of an authentication key, that is, according to whether an authentication key has successfully been read or not (step S12).

When an authentication key is present in the authentication key storage device 202 (YES in step S12), that is, when an authentication key has successfully been read from the authentication key storage device 202, the BIOS 201 starts a predetermined procedure corresponding to the device authentication function of the HDD 116. In the course of the procedure, the BIOS 201 sends out the read authentication key to the HDD 116, and causes the HDD 116 to execute the device authentication process for determining whether the read authentication key agrees with the authentication key in the HDD 116 (step S13).

Subsequently, the BIOS 201 determines whether the device authentication process has successfully been carried out or not (step S14). When the device authentication process has successfully been carried out, that is, when the authentication key in the authentication key storage device 202 agrees with the authentication key in the HDD 116 (YES in step S14), the BIOS 201 read-accesses the HDD 116 and boots up the operating system in the HDD 116 (step S16). In step S16, the BIOS 201 reads a boot loader of the operating system which is stored in the HDD 116. The operating system may be encrypted, like other data. The HDD 116 decrypts encrypted data, the read of which has been requested, and reads out the data (plain data) which is obtained by the decryption.

On the other hand, when the device authentication process has failed, that is, when the authentication key in the authentication key storage device 202 does not agree with the authentication key in the HDD 116 (NO in step S14), the BIOS 201 may power off the computer 10, in cooperation with the EC/KBC 119 (step S15). If the HDD 116 is set to operate in the above-described “Mode 2”, the HDD 116 invalidates the data stored in the HDD 116 when the device authentication process has failed. In this case, the HDD 116 may invalidate the data stored in the HDD 116 by deleting the decryption key that is stored in the HDD 116.

When an authentication key is not present in the authentication key storage device 202 (NO in step S12), that is, when an authentication key has failed to be read from the authentication key storage device 202, the BIOS 201 causes the LCD 16 to display a PIN input screen for prompting the user to input a PIN, and stands by for the PIN input by the user (step S21). If the PIN is input to the PIN input screen, the BIOS 201 sends out the input PIN to the HDD 116 and causes the HDD 116 to execute a PIN authentication process for determining whether the PIN, which has been input to the PIN input screen, agrees with the PIN which is stored in advance in the HDD 116 (step S22).

Based on the result of the PIN authentication process by the HDD 116, the BIOS 201 determines whether the PIN authentication process has successfully been carried out, that is, whether the user is the owner of the HDD 116 (step S23). If the input PIN is an unauthorized PIN, that is, if the input PIN does not agree with the PIN in the HDD 116 (NO in step S23), the BIOS 201 determines that the user is not the owner of the HDD 116, and powers off the computer 10 (step S26).

If the input PIN is the correct PIN, that is, if the input PIN agrees with the PIN in the HDD 116 (YES in step S23), the BIOS 201 determines that the user is the owner of the HDD 116, and starts a process for restoring the computer 10 to the state in which the device authentication process can be executed. The BIOS 201 first executes a process of re-generating an authentication key, that is, a process of generating a new authentication key (step S24). Then, the BIOS 201 stores the generated new authentication key in the authentication key storage device 202 (step S25). In step S25, as described above, the BIOS 201 may not only store the new authentication key in the authentication key storage device 202, but may also re-register the new authentication key in the HDD 116 and change the authentication key in the HDD 116 to the new authentication key. Thereby, the new authentication key may not necessarily be identical to the original authentication key.

When the PIN authentication has successfully be carried out, as in the case where the device authentication process has successfully be executed, the HDD 116 permits the computer 10 to access the data stored in the HDD 116. Accordingly, after the new authentication key is stored in the authentication key storage device 202 and the HDD 116, the BIOS 201 may read-access the HDD 116 and boot up the operating system in the HDD 116 (step S16). Needless to say, after step S25, the BIOS 201 may execute the process of step S11 onwards once again, thereby causing the HDD 116 to execute the device authentication process.

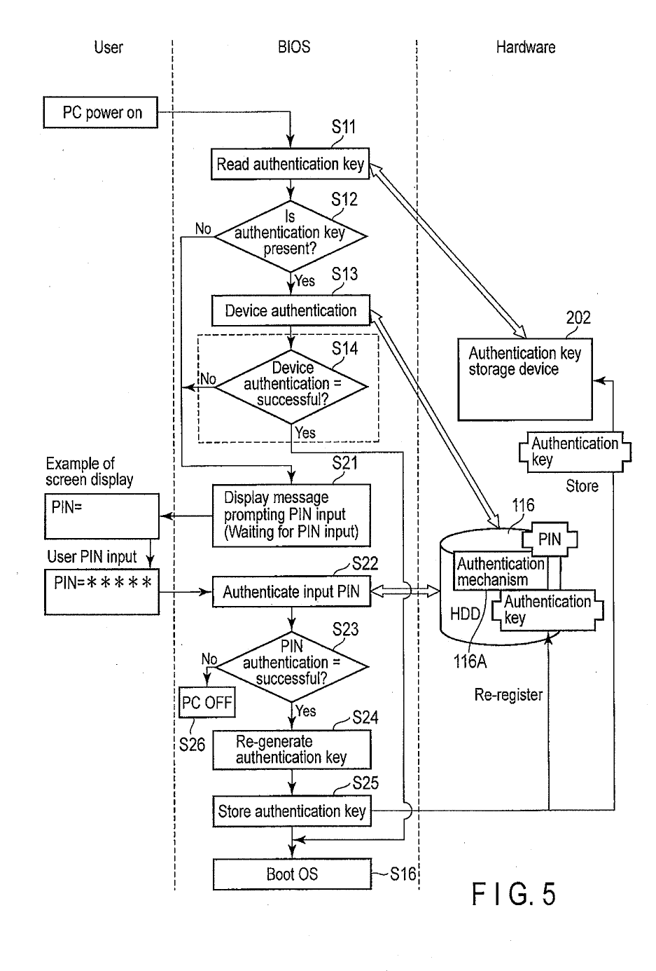

Next, referring to a flow chart of FIG. 5, a description is given of another example of the procedure of the authentication control process which is executed by the BIOS 201. The procedure illustrated in the flow chart of FIG. 5 corresponds to the case in which the HDD 116 is set to operate in the above-described Mode 3.

The procedure illustrated in the flow chart of FIG. 5 differs from the procedure of FIG. 4 with respect to only a part boxed with a broken line in FIG. 5. Specifically, in the procedure illustrated in the flow chart of FIG. 5, the remedy process procedure of step S21 onwards is executed, not only when an authentication key is not present in the authentication key storage device 202, but also when the device authentication process has failed (the part boxed with a broken line in FIG. 5). Thereby, the access to the HDD 116 is enabled, not only when the authentication key in the authentication key storage device 202 has been lost due to, e.g. replacement of the system board, but also when the authentication key in the authentication key storage device 202 has been broken due to some cause (e.g. when an error has occurred in a part of the authentication key in the authentication key storage device 202).

As has been described above, according to the present embodiment, when the authentication key in the authentication key storage device 202 has been lost, the process for restoring the computer 10 to the state, in which the device authentication process can be executed, is executed. Thus, it is possible to flexibly adapt to such a situation that the authentication key has been lost. Therefore, even if a fault which requires replacement of the system board has occurred in the computer 10, the computer 10 can safely be repaired, without invalidating the data in the HDD 116.

Moreover, in the present embodiment, the process for restoring the computer 10 to the state, in which the device authentication process can be executed, is executed before the operating system is booted from the HDD 116 by the BIOS 201. Therefore, before executing a trigger (e.g. read-access) which may possibly invalidate the data in the HDD 116 permanently, the computer 10 can be restored to the state in which the device authentication process can be executed.

In the meantime, the procedure of the authentication control process of the present embodiment may be executed by specific hardware.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage device configured to store a first identification code indicative of an owner of the storage device and a first authentication key;
an authentication key storage device configured to store a second authentication key identical to the first authentication key; and
a controller configured to determine whether the second authentication key is present in the authentication key storage device when the information processing apparatus is powered on, and configured to cause, if the second authentication key is present, the storage device to execute a device authentication process of determining whether the second authentication key agrees with the first authentication key, and, if the second authentication key agrees with the first authentication key, to boot up an operating system stored in the storage device,
wherein the controller is configured to cause a display, if the second authentication key is not present, to display an identification code input screen for inputting an identification code, and configured to cause the storage device to execute an identification code authentication process of determining whether the inputted identification code agrees with the first identification code, and to generate, if the inputted identification code agrees with the first identification code, a third authentication key and store the third authentication key in the authentication key storage device.

2. The information processing apparatus of claim 1,
wherein the controller is configured to change the first authentication key in the storage device to the third authentication key if the identification code authentication process determines that the inputted identification code agrees with the first identification code.

3. The information processing apparatus of claim 1,
wherein the storage device is configured to encrypt data and store the encrypted data, and configured to operate, if the device authentication process determines that the second authentication key does not agree with the first authentication key, in either a first operation mode in which the encrypted data stored in the storage device is invalidated, or a second operation mode in which the encrypted data stored in the storage device is not decrypted until the device authentication process determines that the second authentication key agrees with the first authentication key.

4. The information processing apparatus of claim 1,
wherein the storage device is configured to encrypt data and store the encrypted data, and configured to operate in an operation mode in which the encrypted data stored in the storage device is not decrypted until the device authentication process determines that the second authentication key agrees with the first authentication key, and
wherein the controller is configured to cause the display to display, if the device authentication process determines that the second authentication key does not agree with the first authentication key or if the second authentication key is not present, the identification code input screen, and configured to cause the storage device to execute the identification code authentication process, and to generate, if the identification code authentication process determines that the inputted identification code agrees with the first identification code, the third authentication key and store the third authentication key in the authentication key storage device.

5. An information processing apparatus comprising:
a storage device configured to encrypt data and store the encrypted data, and configured to store a first identification code indicative of an owner of the storage device and a first authentication key, and configured to execute, using the first authentication key, a device authentication process for determining whether a device which uses the storage device is an authorized device, and configured to be set to operate in an operation mode in which the encrypted data stored in the storage device is not decrypted until the device authentication process determines that the device which uses the storage device is an authorized device;
an authentication key storage device configured to store a second authentication key identical to the first authentication key; and
a controller configured to determine whether the second authentication key is present in the authentication key storage device when the information processing apparatus is powered on, and configured to send, if the second authentication key is present, the second authentication key to the storage device and cause the storage device to execute the device authentication process, and configured to boot up an operating system stored in the storage device if the device authentication process determines that the device which uses the storage device is an authorized device,
wherein the controller is configured to cause a display to display, if the second authentication key is not present or if the device authentication process determines that the device which uses the storage device is not an authorized device, an identification code input screen for inputting an identification code and configured to cause the storage device to execute an identification code authentication process of determining whether the inputted identification code agrees with the first identification code, and to generate, if the identification code authentication process determines that the inputted identification code agrees with the first identification code, a third authentication key and store the third authentication key in the authentication key storage device.

6. The information processing apparatus of claim 5,
wherein the controller is configured to change the first authentication key in the storage device to the third authentication key if the identification code authentication process determines that the inputted identification code agrees with the first identification code.

7. An authentication control method applied to an information processing apparatus comprising a storage device, the storage device being configured to store a first identification code indicative of an owner of the storage device and a first authentication key, the method comprising:
determining whether a second authentication key is present in an authentication key storage device in the information processing apparatus when the information processing apparatus is powered on;
causing the storage device to execute a device authentication process to determine whether the second authentication key agrees with the first authentication key if the second authentication key is present;
booting up an operating system stored in the storage device if the device authentication process determines that the second authentication key agrees with the first authentication key;
displaying an identification code input screen for inputting an identification code if the second authentication key is not present;
causing the storage device to execute an identification code authentication process to determine whether the inputted identification code agrees with the first identification code; and
generating, if the identification code authentication process determines that the inputted identification code agrees with the first identification code, a third authentication key, and storing the third authentication key in the authentication key storage device.

8. The authentication control method of claim 7, further comprising changing the first authentication key in the storage device to the third authentication key if the identification code authentication process determines that the inputted identification code agrees with the first identification code.
